(19) United States
(12) Patent Application Publication
(10) Pub. No.: US 2005/0057531 A1
(43) Pub. Date: Mar. 17, 2005

(54) Method and system for generating characters

(76) Inventors: Joseph Patino, Pembroke Pines, FL (US); Wayne W. Ballantyne, Coconut Creek, FL (US)

Correspondence Address: Larry G. Brown;Motorola, Inc., Law Department, 8000 West Sunrise Boulevard, Fort Lauderdale, FL, 33322, US

(21) Appl. No.: 10/664,239

(22) Filed: Sep. 17, 2003

(51) Int. Cl. G09G 5/00

(52) U.S. Cl. 345/174

(57) ABSTRACT

The invention concerns a method (800) and system (100) for generating characters on a display. The method (800) includes the steps of assigning (812) at least one character (124) to one of a plurality of predetermined values that correspond to varying levels of pressure and receiving (816) an applied pressure. The method (800) can also include the step of selecting (820) at least one character (124) in response to the applied pressure in which the character (124) that is selected is assigned to the predetermined value that corresponds to the applied pressure.

### CROSS REFERENCE TO RELATED APPLICATIONS

(Not Applicable)

### BACKGROUND

1. Technical Field

This invention relates in general to touch screen displays and more particularly, to touch screen keyboards on a display.

2. Description of the Related Art

Currently, many mobile communications units (mobile unit), such as cellular telephones or personal digital assistants (PDA), are designed to permit a user to input text that can be transmitted to another mobile unit. Typically, the surface of each button or key on the keypad of the mobile unit includes a series of characters, such as letters and numbers. As an example, in the U.S., each letter of the alphabet is represented on the keys of the keypad. If a user wishes to send a text message, the user can press the keys on the keypad that correspond to the letter that the user wishes to enter in the message. The number of keys on the keypad, however, is limited, and as a result, most keys typically contain or display three or more letters or numbers.

In view of current designs, it can be difficult and tedious to compose a text message. Specifically, a user may have to press a key on the keypad several times before the desired letter appears in the display. This inefficient process may prompt some users to avoid sending text messages at all.

At first glance, it may appear logical to simply add a greater number of keys to the keypad to reduce the number of characters on the keys. Significantly, however, the trend in most mobile units is to decrease the overall unit size and to increase the dimensions of the display.

### SUMMARY OF THE INVENTION

The present invention concerns a method of generating characters on a display. The method can include the steps of assigning at least one character to one of a plurality of predetermined values that correspond to varying levels of pressure and receiving an applied pressure. The method can also include the step of, in response to the applied pressure, selecting at least one character in which the character that is selected is assigned to the predetermined value that corresponds to the applied pressure. The character can be part of a set of characters. The method can further include the steps of assigning to at least one key the predetermined values that correspond to varying levels of pressure and displaying the selected character.

In one arrangement, the predetermined values can be different stored values of contact impedance in which the applied pressure can cause a contact impedance to be generated. Also, the selecting of at least one character step can include measuring the generated contact impedance and comparing the generated contact impedance with the stored values of contact impedance to determine to which predetermined value the applied pressure corresponds.

The generated contact impedance can be inversely proportional to the applied pressure such that the generated contact impedance increases as the applied pressure decreases and the generated contact impedance decreases as the applied pressure increases. In another embodiment, the measuring the generated contact impedance step can include the step of generating a pressure voltage in response to the applied pressure.

As an example, the set of characters can be displayed on at least one key of a keypad having a plurality of keys in which the key displaying the set of characters selectively receives the applied pressure. The method can further include the step of measuring an X-position and a Y-position to determine which of the plurality of keys receives the applied pressure. The measuring an X-position and a Y-position step can include the step of determining a value of at least one X-position impedance and at least one Y-position impedance. In another arrangement, the determining a value of at least one X-position and at least one Y-position impedance step can include the step of generating an X-position voltage and a Y-position voltage. The X-position voltage can be used to determine the value of the X-position impedance, and the Y-position voltage can be used to determine the value of the Y-position impedance.

The selected character can be, for example, a letter, a number or a punctuation symbol. The character can also be displayed on a touch screen display. In one arrangement, at least one of the keys of the keypad can be a shift key, and the method can further include the step of displaying a different set of characters in response to the shift key being pressed. In another arrangement, the method can further include the steps of assigning a function to one of the plurality of predetermined values that correspond to varying levels of pressure and in response to the applied pressure, performing the function that is assigned to the predetermined value that corresponds to the applied pressure.

The present invention also concerns a system for generating characters on a display. The system can include a keypad containing at least one key for displaying a set of characters and for receiving an applied pressure and a processor. The processor is programmed to assign at least one character from the set of characters to one of a plurality of predetermined values that correspond to varying levels of pressure and, in response to an applied pressure, select a character from the set of characters. The character that is selected is assigned to the predetermined value that corresponds to the applied pressure. The system can further include suitable software and circuitry for implementing the method described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for generating characters in accordance with the inventive arrangements;

FIG. 2 illustrates an example of a display of the system of FIG. 1 in accordance with the inventive arrangements;

FIG. 3 illustrates a portion of the display of FIG. 2 in accordance with the inventive arrangements;

FIG. 4 illustrates a processor and processing circuitry of the system of FIG. 1 in accordance with the inventive arrangements;

FIG. 5 illustrates the portion of the display of FIG. 3 and a portion of the processing circuitry of FIG. 4 in accordance with the inventive arrangements;

FIG. 6 illustrates the portion of the display of FIG. 3 and another portion of the processing circuitry of FIG. 4 in accordance with the inventive arrangements.

FIG. 7 illustrates the portion of the display of FIG. 3 and yet another portion of the processing circuitry in accordance with the inventive arrangements.

FIG. 8 illustrates a flowchart that shows the operation of the system of FIG. 1 in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

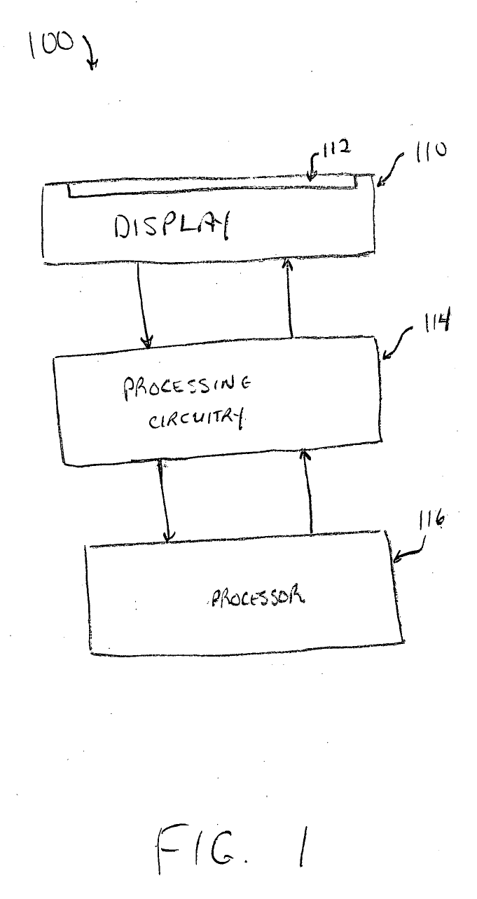

Referring to FIG. 1, a system 100 for generating characters and displaying these characters is shown. The system 100 can include at least one display 110 having a screen 112, processing circuitry 114 and a microprocessor 116. In one arrangement, the display 110 can be a touch-screen display. The characters can be generated when a user touches the screen 112 of the display 110 in certain predefined areas, and these characters can then be displayed on the screen 112. In one arrangement, the type of character to be generated and displayed by the system 100 can depend on the amount of pressure applied by a user to the screen 112. In another arrangement, the system 100 can perform a particular function in response to the user touching the screen 112. The overall interaction of the display 110, the processing circuitry 114 and the microprocessor 116 will be explained later.

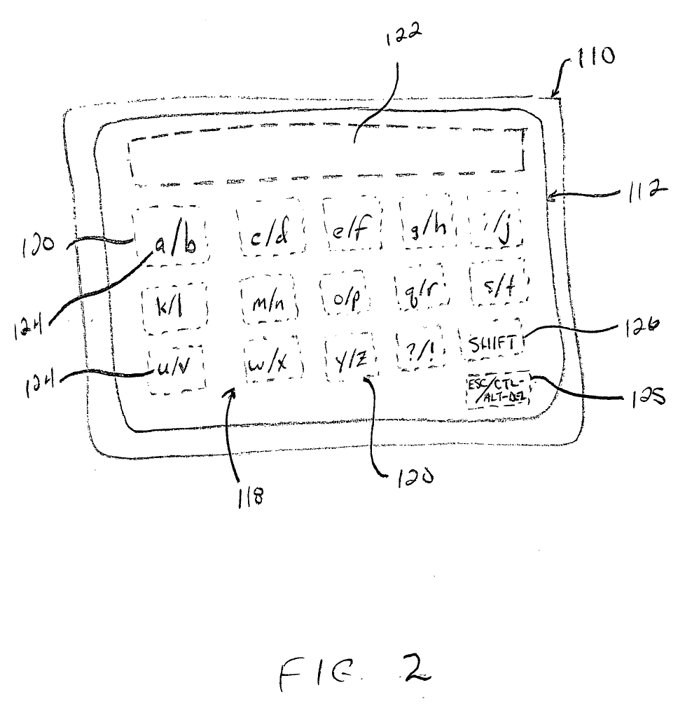

Referring to FIG. 2, an example of the screen 112 of the display 110 is shown. Here, the screen 112 can include a keypad 118 having one or more keys 120, and the screen 112 can also include a display portion 122. Each key 120 can be a predefined area on the screen 112 and when pressed, can cause a particular character to be displayed on the display portion 122 or a particular action to be taken. In one arrangement, each key 120 can display one or more characters 124. Displaying characters on a touch screen is well known in the art, and an explanation of this process is not warranted here. When a key 120 is pressed, at least one of the characters 124 displayed on that key 120 can then be displayed in the display portion 122 of the screen 112 or the system 100 can perform some type of action. As an example, the characters 124 can be letters, numbers, punctuation symbols or any other suitable symbol that can be used in composing any type of message or information.

In one arrangement, each key 120 can display a plurality or a set of characters 124. To cause the display of a particular character 124 on a key 120, a user can vary the pressure to be applied to the key 120. For example, focusing on the key 120 in the upper left-hand corner of the screen 112, if a user wishes to cause the character “a” to be displayed in the display portion 122, the user can press this key 120 with a relatively light pressure. In response, the system 100 will generate and display the character “a.” Conversely, if the user wishes to cause the character “b” to be displayed (located on the same key 120 that the character “a” is on), the user can apply a heavier pressure. The system 100 can then generate and display the character “b.” In this example, characters “a” and “b” can be referred to as a set of characters.

In another arrangement, a user can vary the pressure to be applied to a particular key 120 to cause the system 100 to perform a certain predetermined function. For purposes of the invention, the term “function” can mean any type of action that a processor or any other suitable device can take in response to a key 120 or any set of keys 120 being pressed or activated. For example, one of the keys 120 can be a function key 125 with “ESC/CTL-ALT-DEL” displayed on it. When referring to the keys 120, the function key 125 can be included in such a reference where appropriate. If a user applies a relatively light pressure, then an escape function can be performed. Alternatively, if a heavier pressure is applied to this function key 125, a Control-Alt-Delete function can be performed, which can be similar to the operation performed by simultaneously pressing on a conventional keyboard the control key, the alt key and the delete key. It must be noted, however, that the invention is not limited to these particular examples, as any other suitable function can be performed when a pressure is applied to the function key 125.

It is understood that the invention is in no way limited to the embodiment illustrated in FIG. 2. That is, any suitable number of keys 120 containing any suitable number of characters 124 and that may cause any suitable function to be performed is contemplated by the inventive arrangements. In another arrangement, one of the keys 120 on the screen 112 can be a shift key 126, which, when pressed, can cause different sets of characters 124 to be displayed on the keys 120. When referring to the keys 120, the shift key 126 can be included in such a reference where appropriate. The shift key 126 can increase the number of characters 124 that the system 100 can generate and display without increasing the number of keys 120 on the screen 112. It is understood that the additional characters 124 that can be produced from the operation of the shift key 126 can be selected based on varying levels of pressure applied to the keys 120 as described above. The shift key 126 can also be designed to receive varying levels of pressure. For example, if a relatively light pressure is applied to the shift key 126, a first set of characters 124 can be displayed on each key 120. Conversely, if a relatively heavy pressure is applied to the shift key 126, then a second set of characters 124 can be displayed on the keys 120.

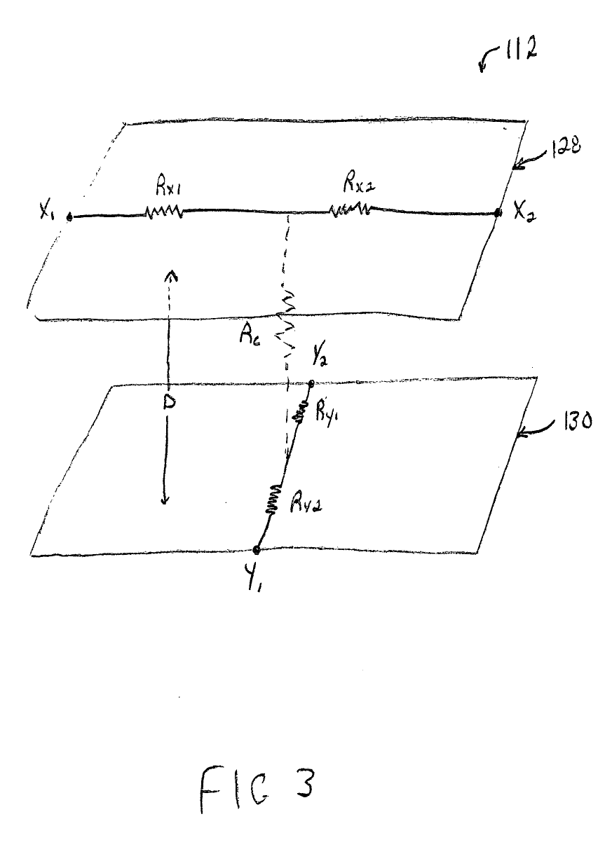

Referring to FIG. 3, a portion of the screen 112 (see FIG. 2) is shown. In one arrangement, the screen 112 can include at least two resistive plates, a first plate 128 and a second plate 130. The first plate 128 and the second plate 130 can be at least substantially parallel and can be separated, for example, when not pressed, by a predetermined distance D, which can be any suitable distance. As an example, the first plate 128 can be used to determine an X-position, i.e., the horizontal element, of any contact made with the screen 112. Similarly, the second plate 130 can be used to determine a Y-position, i.e., the vertical element, of any contact made with the screen 112.

When a user contacts the screen 112, for example, either through his or her finger or a stylus, the first plate 128 can contact the second plate 130, and impedances can be created on and between the first plate 128 and the second plate 130. As an example, the impedance created on the first plate 128 can be represented by the resistors R_{X1} and R_{X2}, and the impedance created on the second plate 130 can be represented by the resistors R_{Y1} and R_{Y2}. Moreover, the impedance created between the first plate 128 and the second plate 130 can be represented by the resistor R_{C}. The impedance created on the first plate 128 can be referred to as an X-position impedance, and the impedance created on the second plate 130 can be referred to as a Y-position impedance. Additionally, the impedance created between the first plate 128 and the second plate 130 can be referred to as a contact impedance, or R_{C}.

The impedances R_{X1} and R_{X2} can scale linearly with the X-position point of contact, and the impedances R_{Y1} and R_{Y2} can scale linearly with the Y-position point of contact. As a result, the changes in the impedances R_{X1} and R_{X2} and the impedances R_{Y1} and R_{Y2} can be used to determine where the user has contacted the first plate 128 and the second plate 130, respectively. This information can be used to determine which key 120 (see FIG. 2) has been pressed. Moreover, the contact impedance R_{C} can be inversely proportional to the applied pressure from the contact. For example, if a relatively light pressure is applied to the screen 1 12, the contact impedance will be relatively high. Conversely, if the pressure applied to the screen 112 is relatively heavy, the contact impedance will be relatively low. The differences in applied pressure and the resultant disparities in contact impedance can be used to discriminate between characters 124 (see FIG. 2) on a key 120 that has been pressed. As a result, a user can select a particular character 124 from a set of characters 124 on a key 120 by adjusting the amount of pressure that he or she applies to the screen 112. This process will be described further below.

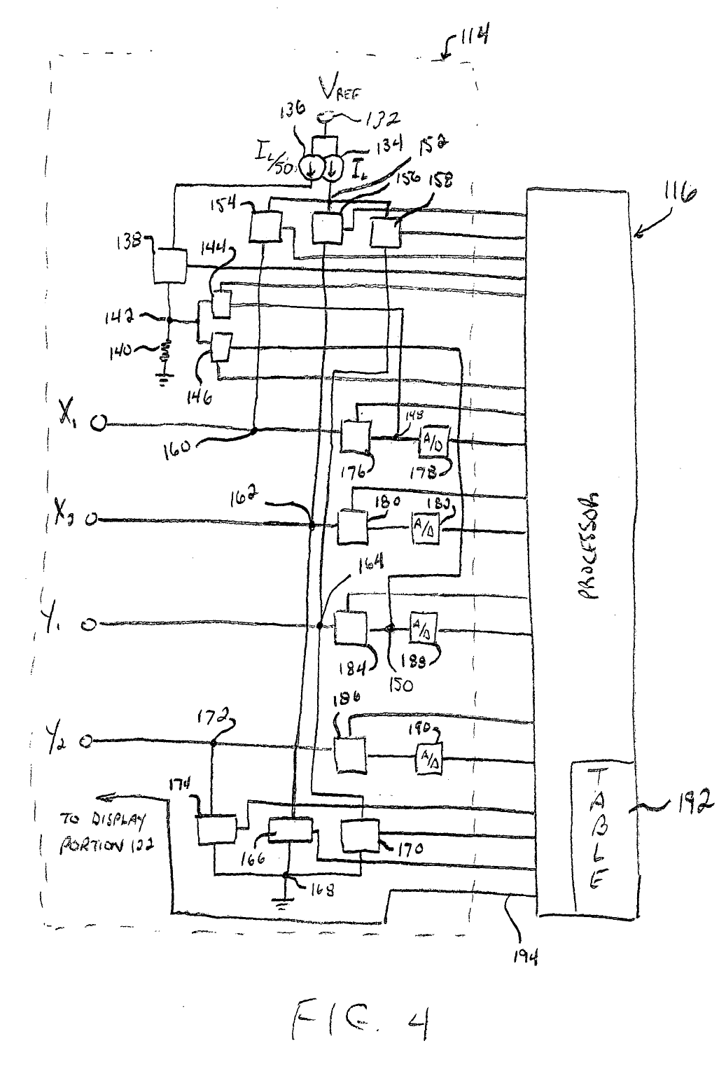

The screen 112 can also include several inputs, X₁, X₂, Y₁ and Y₂. These inputs X₁, X₂, Y₁ and Y₂ can be coupled to processing circuitry 114, as shown in FIG. 4. In FIG. 4, the processing circuitry 114 can contain numerous components, many of which are coupled to the processor 116.

For example, the processing circuitry 114 can include a node 132 that can receive a reference voltage, V_{REF}. The node 132 can be coupled to a current sensor 134 and a current mirror 136. The current sensor 134 can measure a current I_{L}, and the current mirror 136 can produce a current that can be some predetermined fraction of I_{L}. For illustrative purposes only, the current generated by the current mirror can be 1/50 of I_{L}, although other values are within contemplation of the inventive arrangements.

The current mirror 136 can be coupled to a switch 138, whose operation can be controlled by the processor 116. The switch 138 can be coupled to a resistor 140 through a node 142, and the resistor 140 can be coupled to a ground terminal. A pair of switches 144, 146 can also be coupled to the node 142, and the processor 116 can also control the operation of the switches 144, 146. The switch 144 can be coupled to a node 148, which can be coupled between another switch 176 and analog-to-digital (A/D) converter 178. Similarly, the switch 146 can be coupled to a node 150, which can be coupled between a switch 184 and an A/D converter 188.

The current sensor 134 can be coupled to a node 152, which can be coupled to switches 154, 156 and 158, each of which can be controlled by the processor 116. The switch 154 can be coupled to a node 160, which can be coupled to the input X₁, and the switch 156 can be coupled to a node 162, which can be coupled to the input X₂. Further, the switch 158 can be coupled to a node 164, which can be coupled to the input Y₁.

The input X₂ can be coupled to another switch 166 through the node 162, and the switch 166 can be coupled to a ground node 168, which can be connected to a ground terminal. The input Y₁ can be coupled to a switch 170 through the node 164, and the switch 170 can be coupled to the ground node 168. In addition, the input Y₂ can be coupled to a node 172, which can be coupled to a switch 174. The switch 174 can be coupled to the ground node 168. Also, the processor 116 can control the operation of the switches 166, 170 and 174.

In one arrangement, each of the inputs, X₁, X₂, Y₁ and Y₂, can be coupled to the processor 116 through a switch and an A/D converter. As an example, the A/D converters can be eight, ten or twelve bits in resolution. Specifically, the input X₁ can be coupled to the processor 116 through the switch 176 and the A/D converter 178, and the input X₂ can be coupled to the processor 116 through a switch 180 and an A/D converter 182. Likewise, the inputs Y₁ and Y₂ can be coupled to the processor 116 through switches 184, 186 and A/D converters 188, 190, respectively. The processor 116 can control the operation of the switches 176, 180, 184 and 186. In another arrangement, the system 100 can include a single A/D converter, and each of the inputs, X₁, X₂, Y₁ and Y₂, can be coupled to a multiplexer (not shown), which can be coupled to the A/D converter. The processor 116 can set control bits for multiplexing the inputs to such an A/D converter.

Referring to both FIGS. 2 and 4, the processor 116 can include a table 192 and an output 194 to the display portion 122 (see FIG. 2). In one arrangement, the table 192 can contain any number of predetermined values of contact impedance that correspond to varying levels of pressure applied to the screen 112. These predetermined values can be single, discrete values or a range of values. Moreover, the table 192 can also contain the characters 124 that are displayed on each of the keys 120. In another arrangement, the table 192 can also include several values of X-position impedances and Y-position impedances to determine which of the keys 120 has been pressed. These values can also be single, discrete values or a range of values. Thus, during operation, the processor 116 can access the table 192 to determine which character 124 to display based on the position of the contact made on the screen 112 and the amount of pressure applied to the screen 112 during the contact. Similarly, the processor 116 can access the table 192 to carry out a particular function based on which key 120 was pressed and the amount of pressure applied to the key 120.

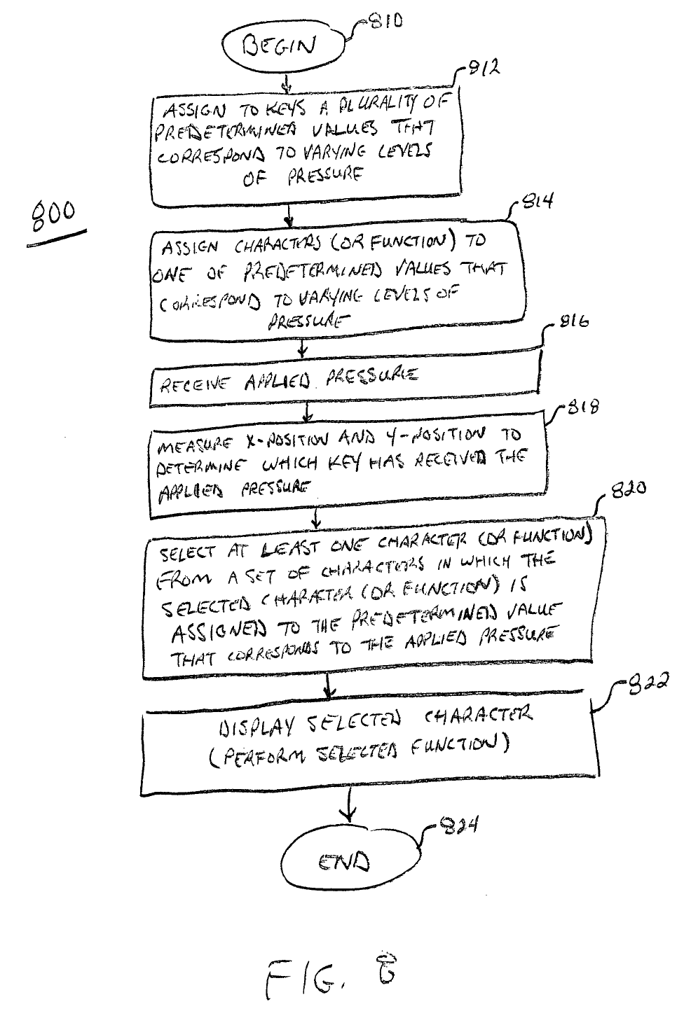

Referring to FIG. 8, a method 800 illustrating the operation of the inventive arrangements is shown. While discussing the method 800, reference will be continuously made those components illustrated in FIGS. 2 through 7. At step 810, the method 800 can begin. At step 812, a plurality of predetermined values that correspond to varying levels of pressure can be assigned to, for example, one or more keys 120. For example, the predetermined values can be different contact impedances and can also, as alluded to earlier, be single, discrete contact impedances or a range of contact impedances. The table 192 of the processor 116 can be loaded with predetermined contact impedances and to which key 120 each of these impedances has been assigned.

At step 814, at least one character 124 can be assigned to one of the plurality of predetermined values, i.e., the predetermined contact impedances. As an example, the characters 124 that are associated with a particular key 120 can be assigned to the predetermined contact impedances that have been assigned to that key 120. Specifically, the table 192 of the processor 116 can be loaded with the predetermined contact impedances, and each of the characters 124 of a particular key 120 can be assigned to one of these contact impedances. As another example and as shown in step 814, a particular function can be assigned to one or more predetermined values, i.e., predetermined contact impedances, and these contact impedances can also be loaded in the table 192. The processor 116 can be programmed to perform a specific act based on these contact impedances, as will be described below.

For example, referring to FIG. 2, the key 120 in the upper left includes two characters 124, an “a” and a “b.” Because there are two characters 124 associated with this key 120, two predetermined contact impedances can be assigned to this key 120. The “a” character can be assigned to a first predetermined contact impedance, and the “b” character can be assigned to a second predetermined contact impedance. This process can be repeated for the other keys 120, and these assigning steps can be used to determine which characters to display on the display portion 122. As another example, referring to FIG. 2 again, two predetermined contact impedances can be assigned to the function key 125 in which a first contact impedance is assigned to the escape function and a second contact impedance is assigned to a control-alt-delete function.

At step 816, an applied pressure can be received. For example, a user can contact the screen 112. In response, an X-position and a Y-position can be measured to determine which of the keys 120 has received the applied pressure, as shown at step 818. Reference will be made to FIGS. 3 through 6 to illustrate this step.

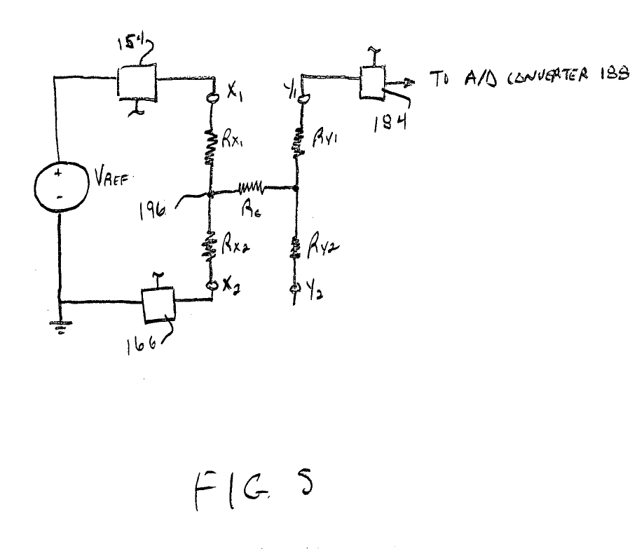

Focusing on the X-position first, the processor 116 can turn on the switches 154,166, 184 and can turn off the remaining switches. A representation of this particular setting is illustrated in FIG. 5. When a user makes contact with the screen 112, a voltage at a node 196 can be generated in which the voltage can be based on where the user makes contact with the screen 112. This voltage can be referred to as an X-position voltage. The X-position voltage at the node 196 is the voltage that is applied to the A/D converter 188. Using this voltage, the processor 116 can determine the X-position impedances, for example, R_{X1} and R_{X2}. Specifically, in addition to the voltage at the node 196, the total X-position impedance, R_{X1}+R_{X2}, and V_{REF} are known. Because the input impedance of the A/D converter 188 is high, the impedances represented by R_{Y1} and R_{C} can be ignored (R_{Y2} does not affect the process because the input Y₂ is floating). As those of ordinary skill in the art will appreciate, the processor 116, using common voltage divider equations, can determine the value of R_{X1}. Once R_{X1} is known, the processor 116 can also determine the value of R_{X2}.

As noted earlier, the table 192 of the processor 116 can contain a set of X-position impedances. These stored values of X-position impedance can reflect different locations on the screen 112 in relation to the horizontal axis of the screen. When the processor 116 determines the X-position impedances R_{X1} and R_{X2}, the processor 116 can compare these generated X-position impedances with the stored values of X-position impedances to ascertain the X-position, or the location along the horizontal axis of the screen 112 that has been contacted. As explained earlier, these X-position values can be either single, discrete values or a range of values. Having a range of values can allow for some tolerance.

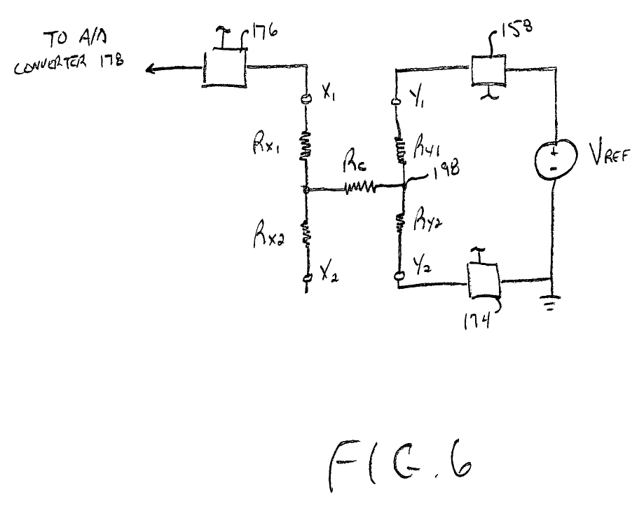

A similar process can be performed for the Y-position. Specifically, the processor 116 can turn on the switches 158, 174 and 176 and can turn off the remaining switches. A representation of this particular setting is shown in FIG. 6. When the user makes contact with the screen 112, a voltage can be generated at a node 198 in which the voltage is based on the location of the contact. This voltage can be referred to as a Y-position voltage. This Y-position voltage can be applied to the A/D converter 178, and using this voltage, the processor 116 can determine the Y-position impedances, for example, R_{Y1} and R_{Y2}. Like the process described above concerning the X-position impedances, the total Y-position impedance, R_{Y1}+R_{Y2}, and V_{REF}, in addition to the voltage at node 198, are known. Also, due to the high input impedance of the A/D converter 178, the impedances represented by R_{X1} and R_{C} are inconsequential. Once again using voltage divider equations, the processor 116 can determine the value of R_{Y1}. The processor 116 can then determine the value of R_{Y2}.

In addition to the set of X-position impedances, the table 192 can contain a set of Y-position impedances (single, discrete values or a range of values) that reflect different locations on the screen 112 in relation to the vertical axis of the screen 112. After calculating the Y-position impedances R_{Y1} and R_{Y2}, the processor 116 can compare these generated Y-position impedances with the stored Y-position impedances to determine the Y-position, or the location along the vertical axis of the screen 112 that has been contacted. Once the X-position and the Y-position are known, the processor 116 can determine which key 120 has been pressed.

As explained earlier, each key 120 can include a set of characters 124. When the processor 116 determines which key has been pressed, the processor 116 can select the character 124 from a set of characters 124 assigned to the pressed key 120 that should be displayed. The selection can be based on the amount of pressure that is applied to the key 120. Thus, referring back to method 800 of FIG. 8, at step 820, in response to the applied pressure, at least one character 124 from the set of characters 124 can be selected in which the character 124 that is selected can be assigned to the predetermined value that corresponds to the applied pressure. The process will be described below.

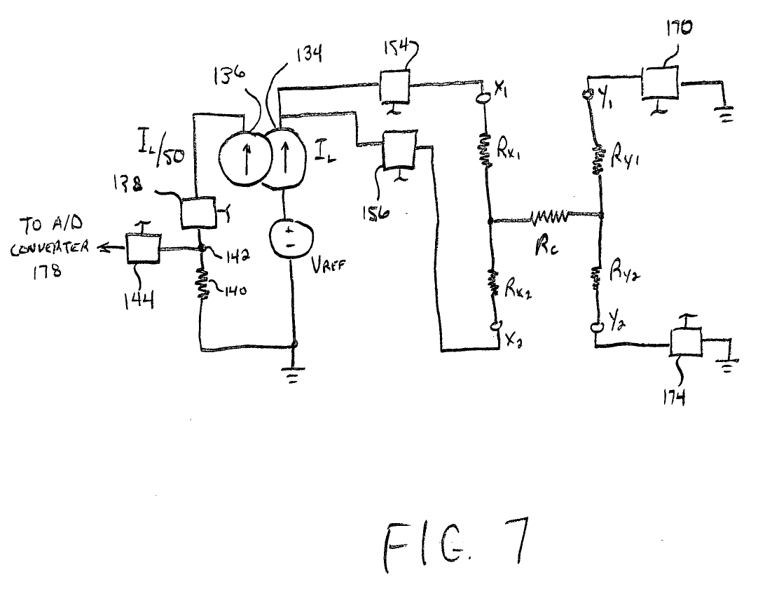

To measure the applied pressure, the processor 116 can turn on the switches 138, 144, 154, 156, 170 and 174 and can turn off the remaining switches. A representation of this particular setting is illustrated in FIG. 7. When the user makes contact with the screen 112, the current sensor 134 can sense the current I_{L}, and the current mirror 136 can output, for example, the current I_{L}/50. As described above, the X-position impedances, R_{X1} and R_{X2}, and the Y-position impedances, R_{Y1} and R_{Y2} are known. The current I_{L}/50 can produce a voltage at the node 142 in view of the resistor 140. This voltage can be referred to as a pressure voltage. In one arrangement, this pressure voltage can be applied to the A/D converter 178. In another arrangement, the switch 146 can be turned on, the switch 144 can be turned off and the pressure voltage can be applied to the A/D converter 188.

In view of the known values, the processor 116 can calculate the contact impedance R_{C} using voltage divider equations. As explained above, the table 192 can store predetermined contact impedances (single, discrete values or a range of values) for each of the keys 120. Because it has previously determined the key 120 that has been pressed, the processor 116 can compare the generated contact impedance with the predetermined contact impedances that are stored in the table 192 and that are associated with the key 120 that has been pressed. When the processor 116 determines that the generated contact impedance matches one of the predetermined contact impedances, the processor 116 can select the character 124 that is assigned to that predetermined contact impedance. That is, the character 124 that is selected is assigned to the predetermined value of contact impedance that corresponds to the pressure that has been applied to the screen 112.

For example, continuing with the example in which the key 120 in the upper left (see FIG. 2) was pressed, the processor 116 can compare the generated contact impedance with the predetermined contact impedances associated with this key 120 that have been stored in the table 192. If the user presses the key 120 with a relatively light pressure, the generated contact impedance can be relatively high, and the processor 116 can select the character 124 that is associated with the predetermined contact impedance that matches this high generated contact impedance, which in this case can be the character “a.” Alternatively, if the user applies a heavier pressure to this key 120, the generated contact impedance can decrease, and the processor 116 can compare this impedance with the predetermined contact impedances stored in the table 192. In this example, because the generated contact impedance has decreased, the processor 116 can select the character 124 that is associated with the predetermined contact impedance that matches this new value, which in this case is the character “b.”

As also shown at step 820, at least one function can be selected in which the selected function is assigned to the predetermined value that corresponds to the applied pressure. As an example, when the processor 116 determines that the generated contact impedance matches one of the predetermined contact impedances in accordance with the above discussion, the processor 116 can perform a particular function. For example, if the user presses the key 125 with a relatively light pressure, the processor 116 can perform a function that is associated with the predetermined contact impedance that matches the high generated contact impedance. In this case, the processor 116 can perform an escape function. If, however, the user presses the key 125 with a relatively heavy pressure, the processor 116 can perform a function that is associated with the predetermined contact impedance that matches the low generated contact impedance. Here, the function can be a control-alt-delete function. It is understood that the invention is in no way limited to these two particular functions, as the system 100 can be designed to accommodate virtually any other function.

Referring back to the method 800 in FIG. 8, once the character 124 has been selected, the character 124 can be displayed, as shown at step 822. For example, following the character 124 selection, the processor 116 can signal the display 110 through the output 194, and the character 124 can be displayed on the display portion 122 (see FIG. 2). In another arrangement and as also shown at step 822, if a function key 125 was selected, then the function can be performed. At step 824, the method 800 can end.

In one arrangement and as noted earlier, one of the keys 120 can be a shift key. If the processor 116 determines that the shift key has been pressed in accordance with the above discussion, the processor 116 can cause different characters 124 to be displayed on the keys 120. These different characters 124 can be associated with X-position, Y-position and predetermined contact impedances stored in the table 192, similar to the examples presented above. Additionally, the shift key 126 can be pressure responsive, which can allow the user to select one of a set of characters 124 to be displayed on the keys 120. Using a shift key can increase the number of characters that can be displayed on the screen 112, which can be even further expanded if the characters 124 can be selected in accordance with varying levels of applied pressure, as described above.

It is important to note that the invention is in no way limited to the system 100, as the system 100 has been selected merely as an example to describe the overall operation of the invention. It is understood that the invention can be implemented into any other suitable system that can permit a user to select characters in which the selection of characters can be based on the location of contact that the user makes with the system and the amount of pressure that the user applies during this contact.

Moreover, the keys 120 described above are shown as containing only two characters 124, which translates into two predetermined contact impedances being stored for each key 120. Those of ordinary skill in the art, however, will appreciate that the keys 120 can contain any suitable number of characters 124 and that any suitable number of predetermined contact impedances can be stored to enable the system 100 to distinguish between a greater number of characters on the keys 120. This same principle applies to the function key 125 and the shift key 126. Also, the keys 120 (which as noted earlier also includes the function key 125 and the shift key 126) are not limited to being contained within a touch screen display, as the keys 120 can be implemented into any other suitable device.

In addition, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of generating characters on a display, comprising the steps of:
assigning at least one character to one of a plurality of predetermined values that correspond to varying levels of pressure;
receiving an applied pressure; and
in response to the applied pressure, selecting the character, wherein the character that is selected is assigned to the predetermined value that corresponds to the applied pressure.

2. The method according to claim 1, wherein the character is part of a set of characters.

3. The method according to claim 1, further comprising the step of assigning to at least one key the predetermined values that correspond to varying levels of pressure.

4. The method according to claim 1, further comprising the step of displaying the selected character.

5. The method according to claim 1, wherein the predetermined values are different stored values of contact impedance, wherein the applied pressure causes a contact impedance to be generated and said selecting the character step further comprises the steps of:
measuring the generated contact impedance; and
comparing the generated contact impedance with the stored values of contact impedance to determine to which predetermined value the applied pressure corresponds.

6. The method according to claim 5, wherein the generated contact impedance is inversely proportional to the applied pressure such that the generated contact impedance increases as the applied pressure decreases and the generated contact impedance decreases as the applied pressure increases.

7. The method according to claim 5, wherein said measuring the generated contact impedance step comprises the step of generating a pressure voltage in response to the applied pressure.

8. The method according to claim 2, wherein the set of characters is displayed on at least one key of a keypad having a plurality of keys, wherein the key displaying the set of characters selectively receives the applied pressure.

9. The method according to claim 8, further comprising the step of measuring an X-position and a Y-position to determine which of the plurality of keys receives the applied pressure.

10. The method according to claim 9, wherein said measuring an X-position and a Y-position step comprises the step of determining a value of at least one X-position impedance and at least one Y-position impedance.

11. The method according to claim 10, wherein said determining a value of at least one X-position and at least one Y-position impedance comprises the step of generating an X-position voltage and a Y-position voltage, wherein the X-position voltage is used to determine the value of the X-position impedance and the Y-position voltage is used to determine the value of the Y-position impedance.

12. The method according to claim 1, wherein the selected character is selected from the group consisting of a letter, a number and a punctuation symbol.

13. The method according to claim 1, wherein the character is displayed on a touch screen display.

14. The method according to claim 8, wherein at least one of the keys of the keypad is a shift key, wherein said method further comprises the step of displaying a different set of characters in response to the shift key being pressed.

15. The method according to claim 1, further comprising the steps of:
assigning a function to one of the plurality of predetermined values that correspond to varying levels of pressure; and
in response to the applied pressure, performing the function that is assigned to the predetermined value that corresponds to the applied pressure.

16. A system for generating characters on a display, comprising:
a keypad containing at least one key for displaying at least one character and for receiving an applied pressure; and
a processor, wherein said processor is programmed to:
assign at least one character to one of a plurality of predetermined values that correspond to varying levels of pressure; and
in response to an applied pressure, select a character, wherein said character that is selected is assigned to said predetermined value that corresponds to the applied pressure.

17. The system according to claim 16, wherein said character is part of a set of characters.

18. The system according to claim 16, wherein said processor is further programmed to assign to at least one key the predetermined values that correspond to varying levels of pressure.

19. The system according to claim 16, further comprising a touch screen display having at least a first plate and a second plate, said first plate including a series of X-position impedances and said second plate including a series of Y-position impedances, wherein said first and second plates are separated by a predetermined distance.

20. The system according to claim 16, wherein said predetermined values are different stored values of contact impedance and said system further comprises processing circuitry, wherein said processing circuitry generates a contact impedance between said first and second plates in response to the applied pressure and wherein said processor is further programmed to:
measure the generated contact impedance; and
compare the generated contact impedance with the stored values of contact impedance to determine to which of said predetermined values the applied pressure corresponds.

21. The system according to claim 20, wherein the generated contact impedance is inversely proportional to the applied pressure such that the generated contact impedance increases as the applied pressure decreases and the generated contact impedance decreases as the applied pressure increases.

22. The system according to claim 20, wherein said processing circuitry further generates a pressure voltage in response to the applied pressure.

23. The system according to claim 20, wherein said keypad is integrated into said touch screen display, wherein said processor, in combination with said processing circuitry, is further programmed to measure an X-position and a Y-position of said touch screen display to determine which of said keys receives the applied pressure.

24. The system according to claim 23, wherein said processor, in combination with said processing circuitry, is further programmed to measure said X-position and said Y-position by determining a value of at least one of said X-position impedances and at least one of said Y-position impedances.

25. The system according to claim 24, wherein said processing circuitry generates an X-position voltage and a Y-position voltage, wherein said processor is programmed to determine the value of said X-position and Y-position impedances based on said X-position and Y-position voltages.

26. The system according to claim 16, wherein said selected character is selected from the group consisting of a letter, a number and a punctuation symbol.

27. The system according to claim 17, wherein at least one of said keys is a shift key and wherein said processor is further programmed to display a different set of characters for selection in response to said shift key being pressed.

28. The system according to claim 16, wherein said processor is further programmed to:
assign a function to one of the plurality of predetermined values that correspond to varying levels of pressure; and
in response to the applied pressure, perform the function that is assigned to the predetermined value that corresponds to the applied pressure.

29. A method of performing a function, comprising the steps of:
assigning at least one function to a plurality of predetermined values that correspond to varying levels of pressure;
receiving the applied pressure; and
in response to the applied pressure, performing the function, wherein the function that is performed is assigned to the predetermined value that corresponds to the applied pressure.
